(19) United States
(12) Patent Application Publication
(10) Pub. No.: US 2016/0210479 A1
(43) Pub. Date: Jul. 21, 2016

(54) COMPUTER-READABLE RECORDING MEDIUM, ENCRYPTING APPARATUS, AND ENCRYPTING METHOD

(71) Applicant: FUJITSU LIMITED, Kawasaki-shi (JP)

(72) Inventors: Masahiro KATAOKA, Kamakura (JP); Eisuke NORIMOTO, Yokohama (JP); Tetsuhiro CHIBA, Sagamihara (JP)

(73) Assignee: FUJITSU LIMITED, Kawasaki-shi (JP)

(21) Appl. No.: 14/997,821

(22) Filed: Jan. 18, 2016

(30) Foreign Application Priority Data
Jan. 19, 2015 (JP) 2015-008092

(51) Int. Cl. G06F 21/71; G06F 21/62; G06F 21/72

(52) U.S. Cl. CPC G06F 21/71; G06F 21/72; G06F 21/6227

(57) ABSTRACT

An encrypting apparatus generates an encoded data from a target file, in units of blocks with a fixed length. The encrypting apparatus creates association information for a plurality of blocks in the encoded data. The association information associates each of a plurality of top encoded codes and each of a plurality of in-file positions of the plurality of blocks. The plurality of top encoded codes are positioned at a beginning of the each of the plurality of blocks in the encoded data. The plurality of in-file positions are positions of the plurality of blocks in the target file. The encrypting apparatus encrypts the encoded data in units of the blocks.

### CROSS-REFERENCE TO RELATED APPLICATION(S)

This application is based upon and claims the benefit of priority of the prior Japanese Patent Application No. 2015-008092, filed on Jan. 19, 2015, the entire contents of which are incorporated herein by reference.

### FIELD

The embodiment discussed herein is related to a computer-readable recording medium having stored therein an encrypting program, and the like.

### BACKGROUND

Compression (encoding) and encryption are indispensable technologies for delivering electronic books, electronic dictionaries, or the like in order to reduce an amount of data transfer or to protect the copyrights. First, an LZ77 type, such as ZIP or the like, in which a longest match character string is searched by using a sliding window is mainly used for compression. Next, common keys conforming to the Advanced Encryption Standard (AES) and public keys based on Rivest Shamir Adieman (RSA) are mainly used for encryption. If compression and encryption are needed, an encryption process is usually performed in two passes after a compression process is performed. Furthermore, sometimes, a decompression (decoding) process is performed in two passes after a decryption process is performed.

Because the compression process reduces the size on the basis of the characteristic, such as the frequency of appearance of a character or the like, the compression process needs to be performed before the encryption process. Furthermore, in the LZ77 compression, such as ZIP or the like, that uses sliding windows, because data is restored in a sliding window at the time of decompression, a decompression process always needs to be performed from the top. With regard to the conventional techniques, see International Publication Pamphlet No, WO 00/52684, Japanese Laid-open. Patent Publication No. 7-222152, and Japanese Laid-open Patent Publication No. 2000-330872, for example.

However, for electronic dictionaries or the like, a high speed search is requested. When searching dictionary data that has been subjected to compression and encryption, there is a problem in that it is not able to partially perform a decryption process and a decompression process. In particular, dictionary data compressed into a variable length in units of bits is collectively compressed into blocks, in units of bytes, each having a fixed length. Consequently, there is a problem in that compressed codes are decoupled between compressed blocks.

This problem will be described with reference to FIG. 1, FIG. 1 is a schematic diagram illustrating an example of a compression encryption process and a decryption/decompression process. In FIG. 1, it is assumed that 1 block/1 sector (2048 bytes) is used. As illustrated in FIG. 1, the compression encryption process compresses the text data in the source file that is the compression source and then generates compressed data, i.e., encoded data. When the compression encryption process divides the generated compressed data into blocks with the fixed length, “unintended separation” (decoupling) of compressed codes occurs at the boundaries between the blocks (sectors). Namely, the compressed codes are decoupled between the blocks.

The compression encryption process assembles data compressed into a variable length in units of bits into a block with a fixed length in units of bytes, compresses the obtained data by using AES in the CEO mode, and generates compression encryption data.

At the time of reproducing, the decryption/decompression (decoding) processes are sequentially performed from the top block in the order of the decryption process and the decompression (decoding) process. Primarily, although a file encrypted by using AES in the CEO mode has an algorithm in which partial decryption can be performed from the middle of the block, it is not able to perform partial decryption and decompression. If the LZ77 compression, such as ZIP, is combined with encryption, a problem of “unintended separation” of compressed, i.e., encoded codes between blocks and a problem of a need to sequentially restore sliding windows from the top data occur and thus it is not able to perform partial decryption and decompression.

### SUMMARY

According to an aspect of an embodiment, a non-transitory computer-readable recording medium has stored therein an encrypting program. The encrypting program causes a computer to execute a process. The process includes: generating an encoded data from a target file, in units of blocks with a fixed length, creating association information for a plurality of blocks in the encoded data, the association information associating each of a plurality of top encoded codes and each of a plurality of in-file positions of the plurality of blocks, the plurality of top encoded codes being positioned at a beginning of the each of the plurality of blocks in the encoded data, each of a plurality of in-file positions being positions of the plurality of blocks in the target file, and encrypting the encoded data in units of the blocks.

According to another aspect of an embodiment, an encrypting apparatus includes a generating unit, a creating unit, and an encryption unit. The generating unit generates an encoded data from a target file, in units of blocks with a fixed length. The creating unit creates association information for a plurality of blocks in the encoded data. The association information associates each of a plurality of top encoded codes and each of a plurality of in-file positions of the plurality of blocks. The plurality of top encoded codes are positioned at a beginning of the each of the plurality of blocks in the encoded data. The plurality of in-file positions are positions of the plurality of blocks in the target file. The encryption unit encrypts the encoded data in units of the blocks.

According to still another aspect of an embodiment, an encrypting method includes: generating, performed by a computer, an encoded data from a target file, in units of blocks; creating, performed by the computer, association information for a plurality of blocks in the encoded data, the association information associating each of a plurality of top encoded codes and each of a plurality of in-file positions of the plurality of blocks, the plurality of top encoded codes being positioned at a beginning of the each of the plurality of blocks in the encoded data, the plurality of in file positions being positions of the plurality of blocks in the target file; and encrypting, performed by the computer, the encoded data in units of the blocks.

The object and advantages of the intention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a compression encryption process and a decryption/decompression process;

FIG. 2 is a schematic diagram illustrating an example of the compression encryption process performed by an information processing apparatus according to an embodiment;

FIG. 3A is a schematic diagram (1) illustrating an example of the flow of the compression encryption process performed by the information processing apparatus according to the embodiment;

FIG. 3B is a schematic diagram (2) illustrating an example of the flow of the compression encryption process performed by the information processing apparatus according to the embodiment;

FIG. 4 is a schematic diagram illustrating an example of a dynamic dictionary unit;

FIG. 5 is a schematic diagram illustrating a configuration example of a compressed file;

FIG. 6 is a schematic diagram illustrating an example partial decryption/decompression process performed by the information processing apparatus according to the embodiment;

FIG. 7A is a schematic diagram (1) illustrating an example of the flow of the partial decryption/decompression process performed by the information processing apparatus according to the embodiment;

FIG. 7B is a schematic diagram (2) illustrating an example of the flow of the partial decryption/decompression process performed by the information processing apparatus according to the embodiment;

FIG. 8 is a functional block diagram illustrating the configuration of the information processing apparatus according to the embodiment;

FIG. 9 is a schematic diagram illustrating an example of the data structure of a Nodeless tree used for compression;

FIG. 10 is a schematic diagram illustrating an example of the data structure of a Nodeless tree used for decompression;

FIG. 11 is a functional block diagram illustrating the configuration of a compression encrypting unit according to the embodiment;

FIG. 12 is a functional block diagram illustrating the configuration of a partial decryption decompressing unit according to the embodiment

FIG. 13A is a flowchart (1) illustrating the flow of a process performed by the compression encrypting unit according to the embodiment;

FIG. 13B is a flowchart (2) illustrating the flow of a process performed by the compression encrypting unit according to the embodiment;

FIG. 13C is a flowchart (3) illustrating the flow of a process performed by the compression encrypting unit according to the embodiment;

FIG. 14A is a flowchart (1) illustrating the flow of a process performed by the partial decryption decompressing unit according to the embodiment;

FIG. 14B is a flowchart (2) illustrating the flow of a process performed by the partial decryption decompressing unit according to the embodiment;

FIG. 15 is a block diagram illustrating an example of hardware configuration of a computer;

FIG. 16 is a schematic diagram illustrating a configuration example of a program operated by the computer; and

FIG. 17 is a schematic diagram illustrating a configuration example of a device in a system of an embodiment,

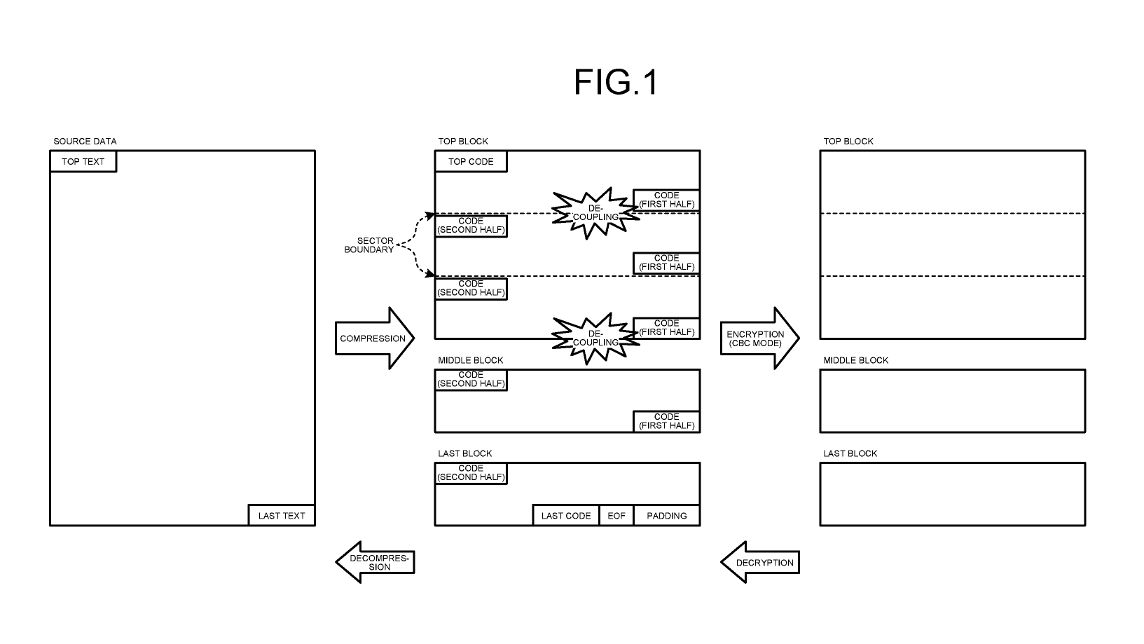

### DESCRIPTION OF EMBODIMENTS

Preferred embodiments of the present invention will he explained with reference to accompanying drawings. The present invention is not limited to the embodiment.

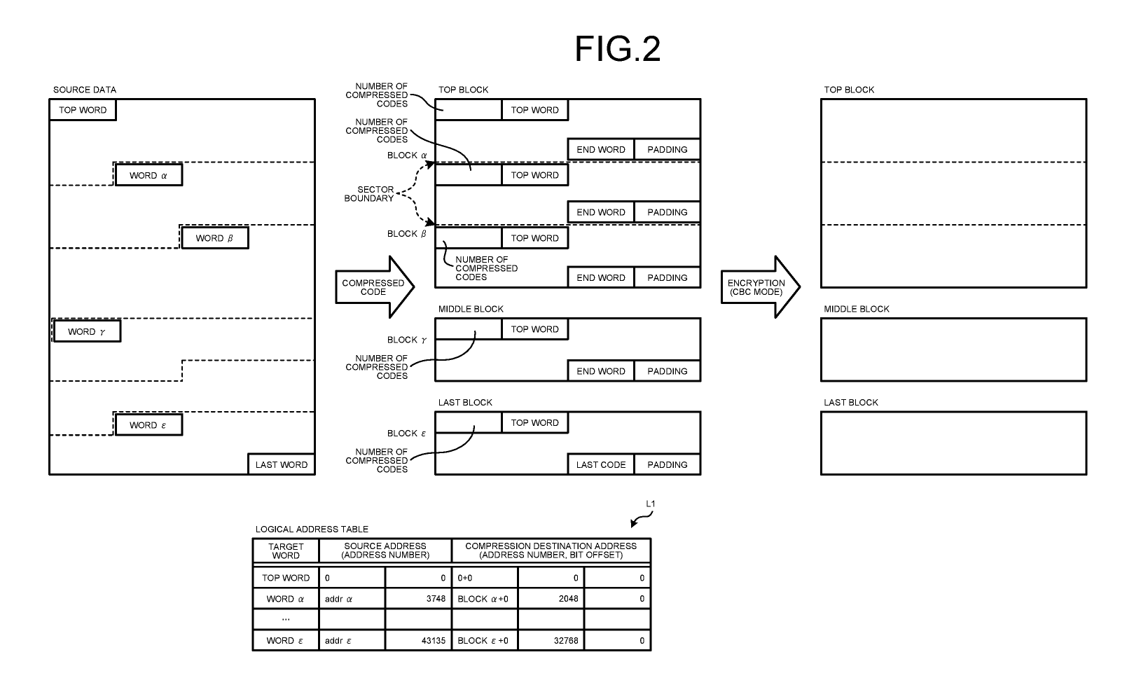

FIG. 2 is a schematic diagram illustrating an example of the compression encryption process performed by an information processing apparatus according to an embodiment. As illustrated in. FIG. 2, when the information processing apparatus compresses, i.e. encodes a source file, the information processing apparatus reads the source file and sequentially extracts the words from the top of the source file. The information processing apparatus compresses the extracted words and stores the compressed codes obtained from the compression in the blocks with a fixed length. The information processing apparatus stores the compressed codes in the blocks with the fixed length by using the number of compressed codes or a padding such that the compressed codes are not to be decoupled between the blocks. The number of compressed codes is the number of compressed codes stored in a block. The padding indicates complement of a portion that is insufficient for a block length and complements, as an example, multiple zeros in units of bits. The length of the block with the fixed length is, for example, 2 KB and a single sector or the assembly of multiple sectors may also be used. In the embodiment, it is assumed that 1 block/1 sector is used.

The information processing apparatus creates a logical address table L1 in parallel with storing, in a block, the compressed codes obtained from being subjected to the compression encoding. The logical address table L1 is a table that stores therein mutual address information between a source address before compression and a compression destination address with respect to a first compressed code in each block obtained after the compression. For example, the logical address table L1 stores therein, in an associated manner, target words or characters, source addresses, and compression destination addresses. The target words or the characters indicate words or characters, in a source file, with respect to the compressed codes that are stored in a block first. The source addresses are the addresses of the target words in the source file and are represented by, for example, address numbers. The compression destination addresses are the top addresses in each block, in which the compressed codes with respect to the target word are stored, and are represented by an address number and a bit offset. As an example, if the target word is a “word α”, the logical address table L1 stores therein the address number of “3748” as the source address of the word α, the address number of “2048” and the bit offset of “0” as the compression destination address of a block α.

The information processing apparatus encrypts, for each fixed block, information included in each block. For example, encryption is performed for each block by using AES in the CBC mode. The encryption in the CBC mode is performed by the EOR operation between the block targeted for the encryption and the block previous to the block targeted for the encryption. Furthermore, for the encryption, the mode is not limited to the CBC mode and any mode may also be used as long as a mode that performs encryption for each block and that can perform partial decompression, i.e., decoding.

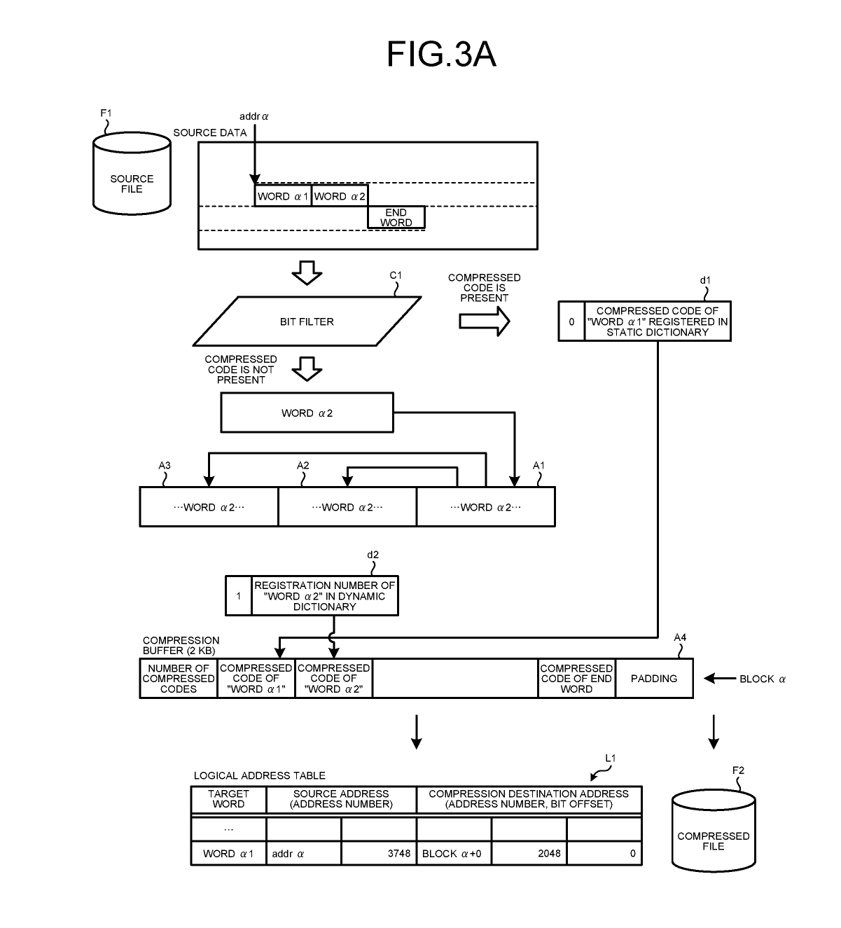

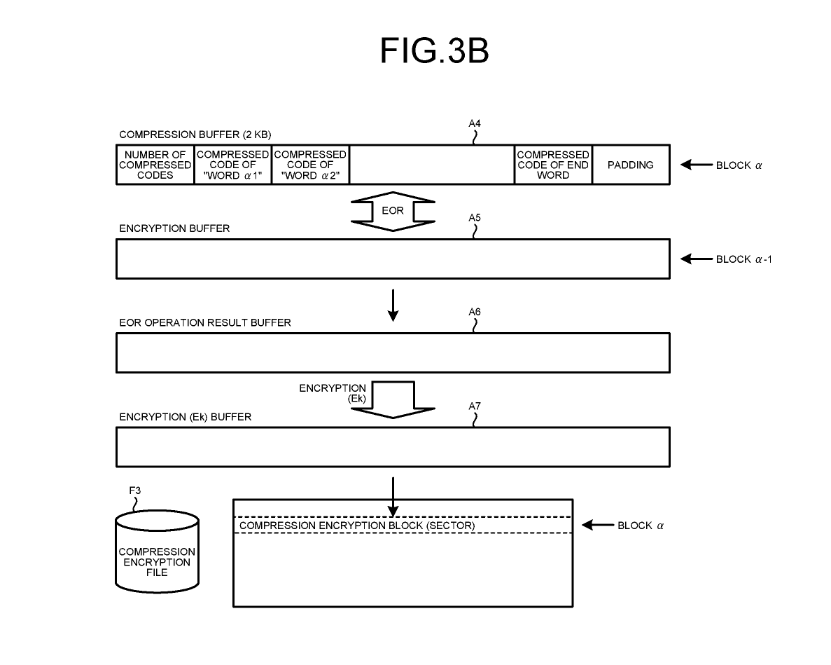

FIGS. 3A and 3B are schematic diagrams each illustrating an example of the flow of the compression encryption process performed by the information processing apparatus according to the embodiment. In FIG. 3A, a description will be given of a process in which the information processing apparatus creates the logical address table L1 in parallel with storing, in a block α, the compressed codes obtained by performing the compression encoding. The information processing apparatus provides, in a memory as the work areas of the compression process, a storage, area A1, a storage area A2, a storage area A3, and a storage area A4. In a description below, the storage area A1, the storage area A2, and the storage area A3 are appropriately referred to as an encoding unit, a referring unit, and a dynamic dictionary unit, respectively. Furthermore, in FIG. 3A, it is assumed that the target word in the source file F1 is a word α1 and assumed that the word α1 is a word with respect to a compressed code that is stored in the block α first. It is assumed that the source address of the word α1 is an addr α.

The information processing apparatus compares a bit filter C1 with a character string of the word α1 and determines whether the character string of the word α1 hits in the bit filter C1. The bit filter is a filter for specifying a character string of a word that is to be compressed by using a static dictionary. If the character string of the word α1 hits in the bit filter C1, the information processing apparatus converts, on the basis of the static dictionary, the character string of the word α1 to a compressed code associated with the word α1 and stores the compressed code in the storage area A4. For example, the information processing apparatus generates compressed data d1 that includes therein both the identifier “0” and the compressed code of the word α1. The identifier “0” is information indicating that the character string has been encoded on the basis of a static dictionary. The information processing apparatus outputs the compressed data da to the storage area A4. The storage area A4 is a compression buffer and has the length of a block length. Here, the storage area A4 stores therein the compressed data associated with the block α.

The static dictionary is a dictionary in which the frequency of appearance of words or characters appearing in a document is specified on the basis of general English dictionaries, Japanese dictionaries, or the like and shorter compressed codes are allocated to the words or characters that have higher frequency of appearance.

In contrast, if the character string of a word α2 does not hit in the static dictionary in the bit filter C1, the information processing apparatus converts the character string of the word α2 to the compressed code, associated with the character string of the word registered in a dynamic dictionary and stores the converted compressed code in the storage area A4. Namely, the dynamic dictionary, a word that does not hit in the hit filter C1 is stored in the encoding unit in the sliding window and is checked against the character string stored in the referring unit. A matched character string is registered in the dynamic dictionary a and the registration number of the matched character is allocated to a compressed code. A description of the dynamic dictionary will he described in detail later. For example, the information processing apparatus stores the character string of the word α2 in the storage area A1, compares the character string stored in the storage area A2 with the character string in the storage area A1, and searches for the longest match character string. The longest match character string is the longest matched character string from among the character strings stored in the storage area A1 and the character strings stored in the storage area A2.

The information processing apparatus registers the longest match character string in the storage area A3 corresponding to the dynamic dictionary unit. The information processing apparatus generates a compressed code on the basis of the registration content in the dynamic dictionary unit. Namely, the information processing apparatus specifies the registration number of the longest match character string registered in the dynamic dictionary unit as the compressed code of the character string of the word α2. The information processing apparatus generates compressed data d2 that includes therein both the identifier “1” and the compressed code of the character string of the word α2. The identifier “1” is information indicating that the character string has been encoded on the basis of the dynamic dictionary. The information processing apparatus outputs the compressed data d2 to the storage, area. A4. Furthermore, the information processing apparatus updates the storage area A2 by adding, as a postscript, the character string of the word α2 stored in the storage area A1 to the storage area A2.

The storage area A2 is a data area in which each data size is defined. For example, the storage area A2 is a storage area with, for example, 64 kilobytes. When the information processing apparatus stores data with the data size equal to or greater than the size defined for the storage area A2, the information processing apparatus stores new data over the old data that is stored in the top position in the storage area A2. For the data to be stored in the storage area A2, the top position is indicated by the relative address from the write position that is updated in accordance with the data to be stored.

The storage area A3 is a storage area in which the data size is defined in accordance with the size of an input file. For example, the storage area A3 is a storage area with, for example, 64 kilobytes. For example, when the information processing apparatus stores data with the data size equal to or greater than the size, defined for the storage, area A3, the information processing apparatus suppresses new data from being stored.

The information processing apparatus determines whether a block length exceeds if compressed data is written in the storage area A4. If a block length does not exceeds if compressed data is written in the storage area A4, the information processing apparatus writes the compressed data in the storage area A4 that functions as the block α.

In contrast, if a block length exceeds when the compressed data is written in the storage area A4, the information processing apparatus does not writes the subject compressed data to the storage area A4 that functions as the block α. The information processing apparatus writes, into the top position in the storage area A4, the number of compressed codes that indicates the number of pieces of the compressed data that have already been written in the storage area A4 functioning as the block α. The information processing apparatus complements the storage area A4 that is associated with the block α by using a padding constituted in units of bits. Then, the information processing apparatus stores, in the compressed file F2, the data of the block α that is stored in the storage area A4. Furthermore, the information processing apparatus writes, in the storage area A4 that functions as the subsequent block α+1, the compressed data that has been determined to have an excessive block length if the compressed data is written in the storage area A4 and then proceeds to the subsequent process to be performed on the subsequent word.

The information processing apparatus adds the information about the block α to the logical address table L1. For example, the information processing apparatus adds a record that includes therein the “word. α1”, as the target word, that is the top word in the block α; the address number of “3748” that indicates the addr α as the source address; and the address number of “2048.” and the bit offset of “0” that indicate the block α+0 as the compression destination address.

In FIG. 3B, a description will he given of a process when the information processing apparatus encrypts the block α. The information processing apparatus provides, in the memory as the work area of the compression process, a storage area A4, a storage area A5, a storage area A6, and a storage area A1. The storage area A4 is a compression buffer and stores therein data associated with the block α. The storage area A5, the storage area A6, and the storage area A7 are used to encrypt a block.

The information processing apparatus performs an EOR operation between the data in the block α that is stored in the storage, area A4 and that has been subjected to the compression encoding and the data in the block α−1 that is stored in the storage area A5 and that has been encrypted and the stores the result of the EOR operation in the storage area A6. Furthermore, if the block is a first block, the EOR operation between the initial value IV of n bits and the result of the EOR operation is stored in the storage area A6. The storage area A5 is, for example, an encryption buffer. The storage area A6 is an EOR operation result buffer. The information processing apparatus performs an operation of the result of the EOR operation by using the affine encryption function (Ek), encrypts the block α, and stores the block a in the storage area A7. The storage area A7 is an encryption (Ek) buffer. The information processing apparatus stores, in the compression encryption file F3, the data in the compression encryption block stored in the storage area A7. Namely, the information processing apparatus encrypts the block α that has been subjected to the compression encoding.

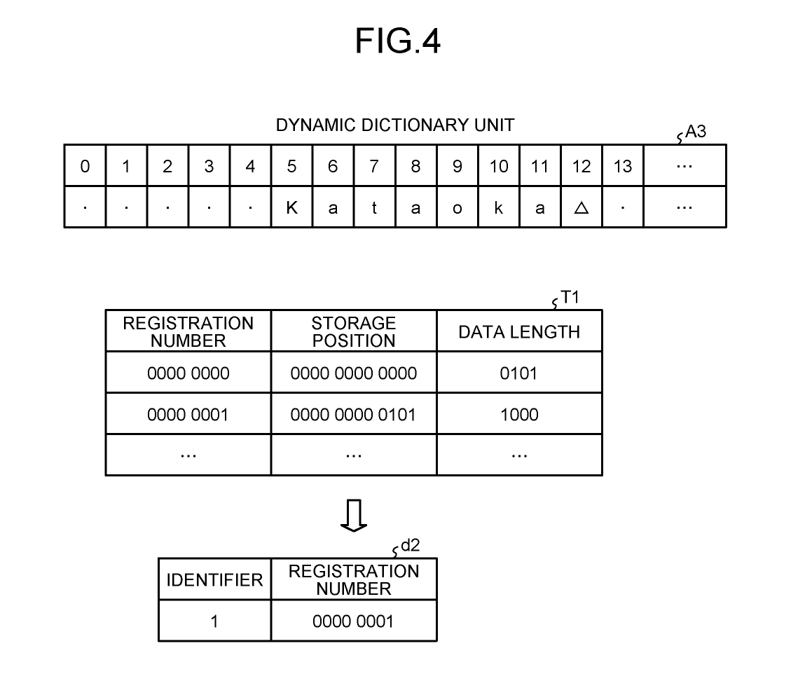

FIG. 4 is a schematic diagram illustrating an example, of a dynamic dictionary unit. The dynamic dictionary unit illustrated in FIG. 4 includes therein the storage area A3 and a reference table T1. The reference table T1 stores therein, in an associated manner, the registration number, the storage position, and the data length. In the example illustrated in FIG. 4, the registration number, the storage position, and the data length are represented by the binary numbers. The registration number is information indicating the order of registration of the longest match character string registered in the storage area A3. Furthermore, in the embodiment, it is assumed that the registration number of the data that is registered first is set to “00000000”. The storage position is information indicating the position (byte) of the first character of the longest match character string stored in the storage area A3. The data length is information indicating the length of the longest match character string.

For example, if the longest match character string “KataokaΔ” is the longest match character string that is registered as the fifth registration in the storage area A3, the information processing apparatus registers “00000001” as the registration number associated with the longest match character string “KatackaΔ” in the registration number in the reference table T1. Furthermore, because the first character “K” of the longest match character string “KataokaΔ” is stored in “5” in the storage area A3, the information processing apparatus registers “000000000101” in the storage position. Because the data length of the longest match character string “RataokaΔ” is “8”, the information processing apparatus registers “1000” in the data length.

As illustrated in FIG. 4, if it is assumed that the longest match character string “KataokaΔ” has been registered in the dynamic dictionary unit, the registration number of the longest match character string “KataokaΔ” is “00000001”. In this case, the information processing apparatus sets the compressed code of the character string “KataokaΔ” as “00000001”. Consequently, the information processing apparatus generates, as compressed data d2 of the character string “RataokaΔ”, the compressed data d2 that includes therein both the identifier “1” and the registration number “00000001”.

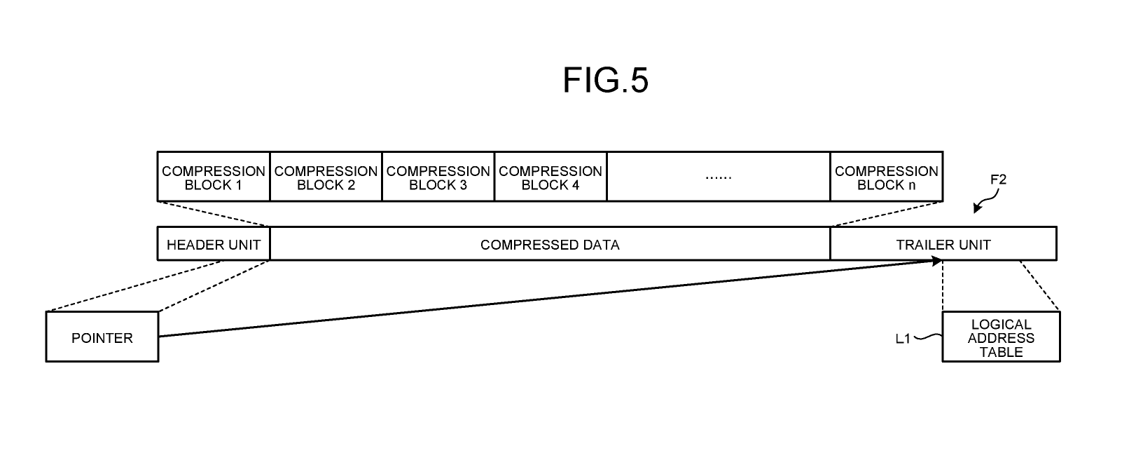

FIG. 5 is a schematic diagram illustrating a configuration example of a compressed file. As illustrated in FIG. 5, a compressed file F2 includes a header unit, compressed data, and a trailer unit. The trailer unit stores therein the logical address table L1 obtained after the compression process has been completed and the information stored in the dynamic dictionary unit A3. The logical address table L1 corresponds to the logical address table illustrated in FIG. 3A. The information in the dynamic dictionary unit A3 corresponds to the information in the dynamic dictionary unit illustrated in FIG. 4. The header unit stores therein a pointer to the logical address table L1 that is stored in the trailer unit. Furthermore, the header unit stores therein the pointer to the information in the dynamic dictionary unit A3 that is stored in the trailer unit. The information processing apparatus can refer to the logical address table L1 by using the pointer, in the header unit, to the logical address table L1 at the time of partial decryption and decompression (decoding), which will be described later. Furthermore, the logical address table L1 is preferably registered, in the trailer unit, from the top of an independent block. Consequently, because the trailer unit is encrypted in the same way as the compressed data, when the partial decryption and decompression is performed, the information processing apparatus can speed up the partial decryption and decompression by decrypting the logical address table L1 at a high speed.

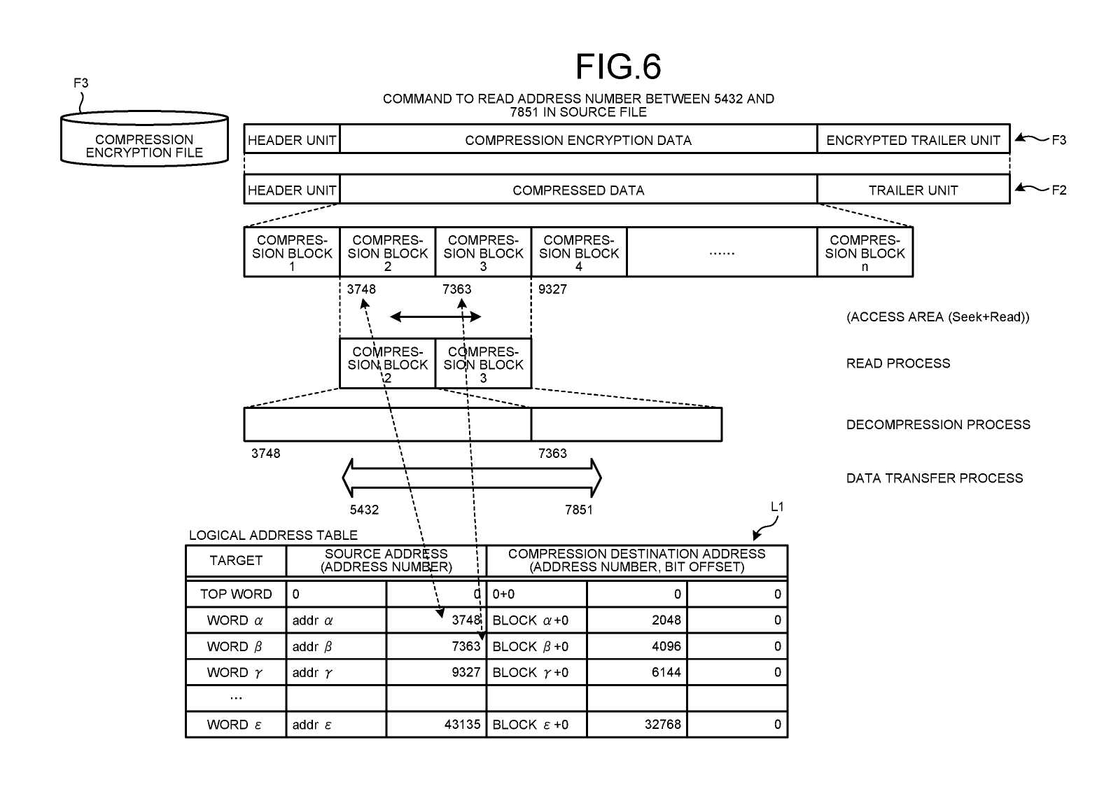

FIG. 6 is a schematic diagram illustrating an example of a partial decryption/decompression process performed by the information processing apparatus according to the embodiment. As illustrated in FIG. 6, when the information processing apparatus performs the partial decryption and decompression on compression encryption data, the information processing apparatus acquires, from an application, a read command that indicates the start and the end positions of the source file F1. The information processing apparatus decrypts the block specified by the pointer, which is stored in the header unit, to the logical address table L1. This is to decrypt the logical address table L1. The information processing apparatus refers to the logical address table L1 and specifies the block associated with the specified tart and the end positions as the decompression target. The information processing apparatus decrypts the block specified as the decompression target. The information processing apparatus decompresses the decrypted block. The information processing apparatus extracts, from the data in the decompressed block, the data associated with the start and the end positions.

Here, a description will be given of a partial decryption/decompression process performed when the information processing apparatus acquires a command to read the address number between 5432 and 7851 in the source file. The information processing apparatus decrypts the logical, address table L1 by decrypting the block indicated by the pointer, which is stored in the header unit, to the logical address table L1. The information processing apparatus refers to the logical address table L1 and specifies, as the decompression target, the block that includes therein the data from the address number of 5432 that is the indicated start position to the address number of 7851 that is the indicated end position. In this case, because the address number of 5432 that is the start position is present between the address number of 3748 and the address number of 7363 in the source address, the address number of 5432 is included in the block a (compression). Because the address number of 7851 that is the end position is present between the address number of 7363 and the address number of 9327 in the source address, the address number of 7851 is included in the block β. The information processing apparatus specifies the block α and the block β as the decompression targets.

The information processing apparatus reads, from the compression encryption file F3, the block α, the block β, and the block needed to be decrypted that are specified as the decompression target. The information processing apparatus performs the partial decryption process on the block α and the block β. Consequently, the information processing apparatus generates a compression block 2 that is a block in which the block α has been decrypted and a compression block 3 that is a block in which the block β has been decrypted. The partial decryption process will be described in detail later.

The information processing apparatus performs a partial decompression process on the compression block 2 and the compression block 3. Consequently, the information processing apparatus generates, for the compression block 2, decompressed data that includes therein the address number of 3748 to the address number of 7362 in the source file F1, The information processing apparatus generates, for the compression block 3 decompressed data that includes therein the address number of 7363 to the address number of 9326 in the source file F1. The partial decompression process will be described in detail later.

The information processing apparatus extracts, from the generated decompressed data, the decompressed data from the address number of 5432 that is the indicated, start position to the address number of 7851 that is the indicated end position.

The information processing apparatus transfers the extracted decompressed data to the application indicated by the read command.

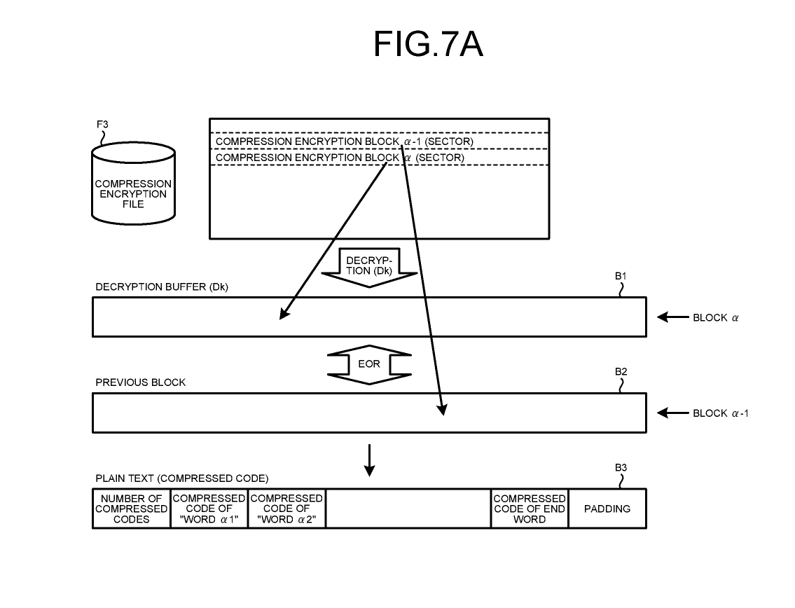

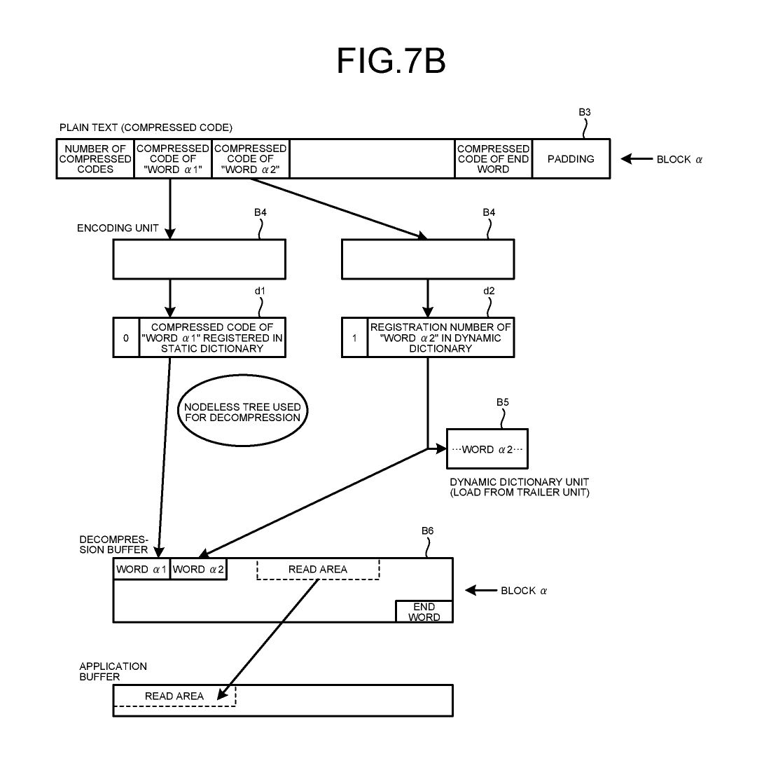

in the following, FIGS. 7A and 7B are schematic diagrams each illustrating an example of the flow of the partial decryption/decompression process performed by the information processing apparatus according to the embodiment. In FIG. 7A, a partial decryption process performed by the information processing apparatus will be described. The information processing apparatus provides, in the memory as the work area of the partial decryption process, a storage area B1, a storage area B2, and a storage area B3. Furthermore, in FIG. 7A, it is assumed that the information processing apparatus refers to the logical address table L1 and specifies the block α as the decompression target.

The information processing apparatus reads the block α from the compression encryption file F3, performs an operation of the decryption function (Dk) on the data in the block α, decrypts the block α, and stores the decrypted block α in the storage area B1. The storage area B1 is a decryption buffer (Dk). The information processing apparatus reads a block α−1 that is immediately previous to the block α from the compression encryption file F3, and store the block α−1 in the storage area 52. The block α−1 is a block needed to decrypt the block α. Then, the information processing apparatus performs the EOR operation between the data in the decrypted block α stored in the storage area B1 and the data in the block α−1 that has been subjected to the compression encryption and that is stored in the storage area B2 and then stores the result of the EOR operation in the storage area B3. Namely, the information processing apparatus decrypts the block a that has been subjected to the compression encryption and generates a plain text that includes therein the number of compressed codes, the compressed data and the padding.

In FIG. 7B, a partial decompression process performed by the information processing apparatus will be described. The information processing apparatus provides, in the memory as the work area of the partial decompression process, a storage area B3, a storage area B4, a storage area B5, and a storage area B6. The information processing apparatus loads, in the storage area B5, the information in the dynamic dictionary unit stored in the trailer unit illustrated in FIG. 5. The information processing apparatus sequentially reads the compressed data in the block α stored in the storage area B3. The information processing apparatus generates decompressed data on the basis of the read compressed data. In a description below, the storage area B4 is appropriately referred to as an encoding unit and the storage area B5 is appropriately referred to as a dynamic dictionary unit. A decompression process performed on the compressed data d1 and d2 included in the block α illustrated in FIG. 3A.

The information processing apparatus reads the compressed data d1 and decides the identifier of the compressed data d1. If the identifier of the compressed data d1 is “0”, the information processing apparatus decides that the compressed data d1 has been encoded by the static dictionary. The information processing apparatus compares the compressed data d1 with the Nodeless tree that is used for decompression and specifies the decompressed data indicated by the Nodeless tree that is used for the decompression. Here, the decompressed data is the word α1. The information processing apparatus writes the word α1 that is the decompressed data into the storage area B6. The storage area 56 is a decompression buffer.

The information processing apparatus reads the compressed data d2 and decides the identifier of the compressed data d2. If the identifier of the compressed data d2 is “1”, the information processing apparatus decides that the compressed data d2 has been encoded by the dynamic dictionary. The information processing apparatus refers to the dynamic dictionary unit on the basis of the compressed codes in the compressed data and generates the decompressed data. Here, the decompressed data is the word α2. The information processing apparatus writes the word α2 that is the decompressed data into the storage area B6,

In this way, the information processing apparatus sequentially decompresses the compressed data included in the block α and sequentially writes the decompressed data into the storage area B6. The information processing apparatus extracts, from the decompressed data written into the storage area B6, the decompressed data (read area) from the indicated start position to the indicated end position. As an example, it is assumed that the address number in the source file F1 associated with the block α is the address number of 3748 based on the logical address table L1. If the start position that was indicated by the read command is the address number of 5432 and if the end position is the address number of 7851, the information processing apparatus extracts the decompressed data (read area) that corresponds to the address number equal to (7851-5432) from the position in which the address number equal to (5432-3748=1684) is offset from the top position in the storage area B6.

The information processing apparatus transfers the extracted decompressed data (read area) to an application indicated by the read command.

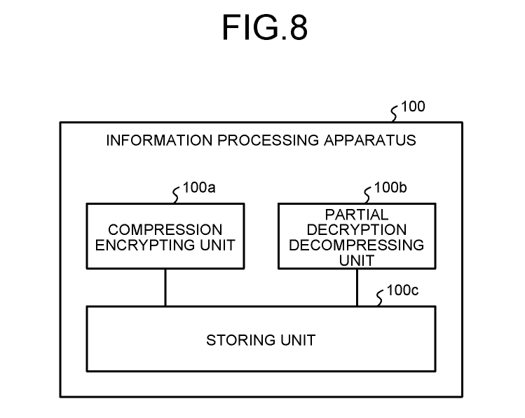

FIG. 8 is a functional block diagram illustrating the configuration of the information processing apparatus according to the embodiment. As illustrated in FIG. 8, an information processing apparatus 100 includes a compression encrypting unit 100a, a partial decryption decompressing unit 100b, and a storing unit 100c.

The compression encrypting unit 100a is a processing unit that performs the compression encryption process illustrated in FIGS. 2, 3A, and 3B. The partial decryption decompressing unit 100b is a processing unit that performs the partial decryption/decompression process illustrated in FIGS. 6, 7A, and FIG. 7B. The storing unit 100c stores therein the source file F1 that is targeted for the compression encryption, the compressed file F2 that is obtained by the compression process, the compression encryption file F3 that is obtained by encrypting the compressed file F2, and the like.

Furthermore, the information processing apparatus 100 sets the storage areas A1, A2, A3, A4, A5, A6, and A7 illustrated in FIGS. 3A, 3B, and the like in the storing unit 100c. The information processing apparatus 100 sets the storage areas B1, B2, B3, B4, B5, and B6 illustrated in FIGS. 7A, 7B, and the like in the storing unit 100c. Furthermore, the storing unit 100c stores therein the Nodeless tree that is used for compression and the Nodeless tree used for decompression.

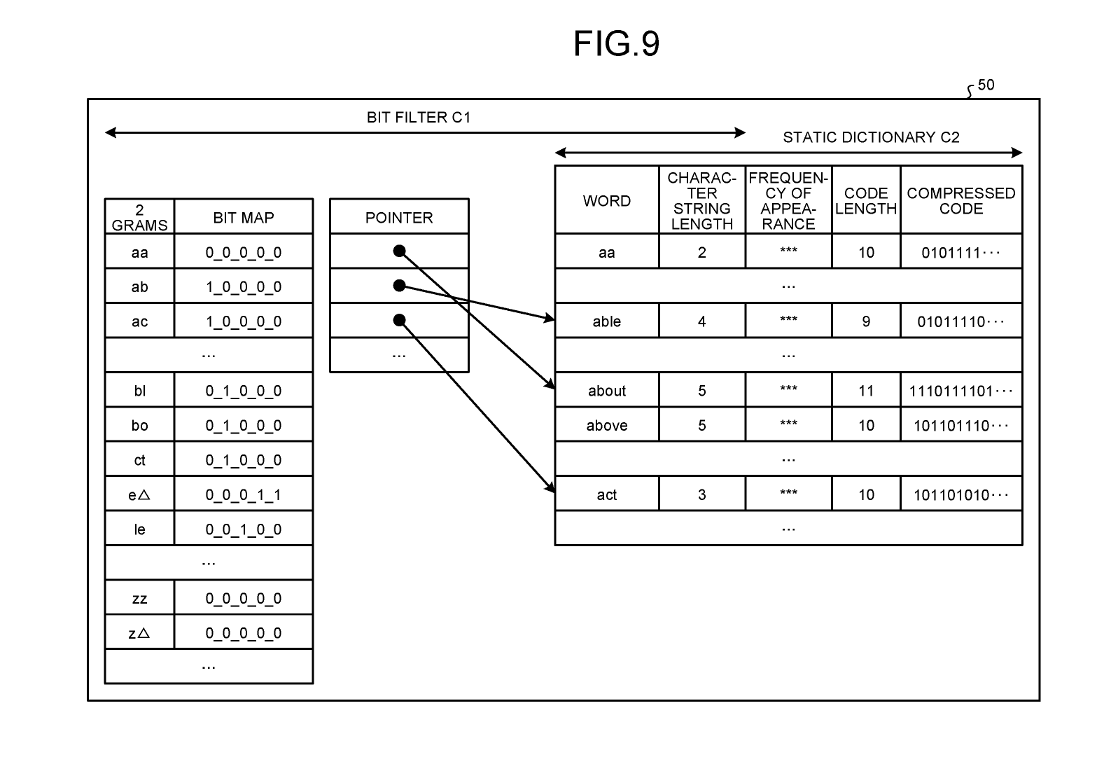

FIG. 9 is a schematic diagram illustrating an example of the data structure of a Nodeless tree used for compression. As illustrated in FIG. 9, a Nodeless tree 50 used for the compression includes 2 grams, a bit map, a pointer, a basic word, a character string length, frequency of appearance, a code length, and a compressed code. Among these, the 2 grams, the bit map, the pointer, the word, and the character string length are associated with the bit filter C1. Furthermore, the word, the character string length, the frequency of appearance, the code length, and the compressed code are associated with the static dictionary C2.

The grams is information that indicates a character string with two characters. The bit map indicates a bit map associated with the character string of the 2 grams. For example, the bit map associated with “aa” is “0_0_0_0_0”. The pointer is a pointer that indicates the position of the word associated with the bit map.

The word is a word registered in the static dictionary C2. In the word, not only English characters but also Japanese words, CJK characters, or the like are also included. The character string length is the character string length associated with a word. The frequency of appearance is the frequency of appearance of a word. The code length is the code length of a compressed code. The compressed code is a compressed code allocated to a word.

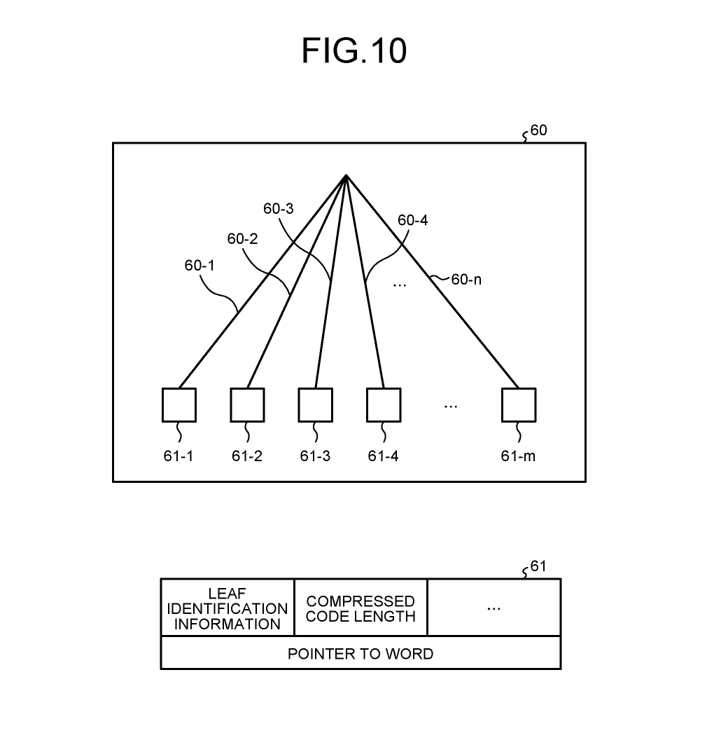

FIG. 10 is a schematic diagram illustrating an example of the data structure of a Nodeless tree used for decompression. As illustrated in FIG. 10, a Nodeless tree 60 used for decompression includes a plurality of branches 60-1 to 60-n and leaves 61-1 to 61-m. A predetermined bit string is allocated to each of the branches 60-1 to 60-n. The information processing apparatus 100 compares the bit string of the compressed data with the bit strings allocated to the branches 60-1 to 60-n and specifies a leaf that is connected to the branch that is hit in the bit string in the compressed data. In a leaf, the information in the character string associated with the compressed data is stored.

For example, the data structure of the leaves becomes the state indicated by 61. For example, in a leaf, leaf identification information, a compressed code length, and a pointer to a word are stored. The leaf identification information is information that is used to uniquely identify a leaf. The compressed code length is information that indicates a valid length in a bit string of the compressed data that has been compared with each of the branches 60-1 to 60-n. The pointer to a word is information that uniquely indicates decompressed data when the compressed code is decompressed.

For example, it is assumed that the bit string “010111110111101” hits in a branch 60-4, assumed that the compressed code length of the leaf 61-4 connected to the branch 60-4 is “11”, and assumed that the word indicated by the pointer to the word is “talkΔ”. In this case, the bit string “01011111011” starting from the top of the bit string to the 11^{th} bit becomes the compressed code that is associated with the word “talkΔ”.

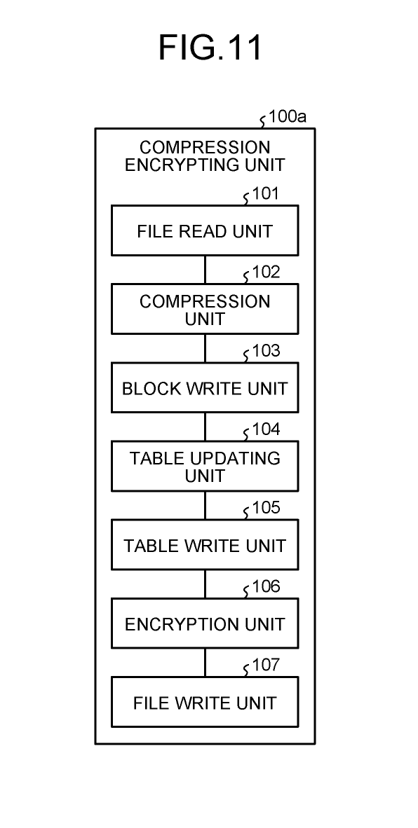

FIG. 11 is a functional block diagram illustrating the configuration of a compression encrypting unit according to the embodiment. As illustrated in FIG. 11, the compression encrypting unit 100a includes a file read unit 101, a compression unit 102, a block write unit 103, a table updating unit 104, a table write unit 105, an encryption unit 106, and a file write unit 107.

The file read unit 101 is a processing unit that reads data of the content portion in the source file F1. The file read unit 101 extracts words from the top and sequentially outputs the extracted words to the compression unit 102. For example, if the data of the content portion in the source file F1 is the word α1 and the word α2, the file read unit 101 outputs each of the words to the compression unit 102 in the order of the word α1 and the word α2.

The compression unit 102 is a processing unit that compresses a word. The compression unit 102 compares the character string of the word with the bit filter C1 and determines whether the character string of the word hits in the bit filter C1. If the character string of the word hits in the bit filter C1, the compression unit 102 encodes the character string of the word on the basis of the static dictionary C2. For example, the compression unit 102 refers to the static dictionary C2, specifies the word associated with the character string from the static dictionary C2, and specifies the compressed code associated with the specified word. Then, the compression unit 102 generates compressed data that includes therein the identifier of “0” and the compressed code of the character string registered in the static dictionary C2 and then outputs the compressed data to the block write unit 103.

If the character string of the word is not hit in the bit filter C1, the compression unit 102 encodes the character string of the word on the basis of the dynamic dictionary. For example, the compression unit 102 stores the character string of the word in the storage area A1 that becomes the encoding unit. The compression unit 102 compares the E age area A1 with the data that is stored is the storage, area A2 that becomes the referring unit and searches for the longest match character string. The compression unit 102 registers the longest match character string in the storage, area A3 in the dynamic dictionary unit. The compression unit 102 generates compressed code on the basis of the registration content of the dynamic dictionary unit. Namely, the compression unit 102 specifies, as the compressed code of the character string, the registration number of the longest match character string registered in the dynamic dictionary unit. The compression unit 102 generates compressed data that includes therein the identifier of “1” and the registration number in the dynamic dictionary and then outputs the compressed data to the block write unit 103.

The block write unit 103 is a processing unit that stores therein the compressed data in a block with a fixed length. The block write unit 103 determines whether the block length exceeds if the compressed data is written into the storage area A4. If the block length does not exceed when the compressed data is temporarily written in the storage area A4, the block write unit 103 temporarily writes the subject compressed data into the storage area A4. If the block length exceeds when the compressed data is temporarily written into the storage area A4, the block write unit 103 does not write the subject compressed data into the storage area A4. The block write unit 103 writes, in the to in the storage area A4, the number of compressed codes indicating the number of compressed data that has already been written into the storage area A4. The block write unit 103 complements a remaining area in the storage area A4 by using a padding. The block write unit 103 stores, as a compression block, the block stored in the storage area A4 in the compressed file F2. The block write unit 103 outputs the information about the compression block stored in the storage area A4 to the table updating unit 104.

The block write unit 103 writes the compressed data that has been determined to have the excessive block length if the compressed data is written in the storage area A4. Namely, the block write unit 103 writes the compressed data into the storage area A4 that functions as the subsequent block.

The table updating unit 104 is a processing unit that adds the information about the compression block to the logical address table L1. The table updating unit 104 adds, to the logical address table L1, the record including the target word, the source address, and the compression destination address that are associated with the subject block. In the target word, the top word that is associated with the subject block and that is stored in the source file F1 is set. In the source address, the address (en address number) of the top word in the source file F1 is set. In the compression destination address, the address (an address number and a bit offset) of the subject block in the compressed file F2 is set.

The table write unit 105 is a processing unit that stores the logical address table L1 in a trailer unit in the compressed file F2. After the compression process performed on the data in the source file F1 has been completed, the table write unit 105 stores the logical address table L1 in trailer unit in the compressed file F2. Then, the table write unit 105 stores, in the header unit in the compressed file F2, the pointer to the logical address table L1 stored in the trailer unit.

The encryption unit 105 is a processing unit that encrypts a block. The encryption unit 106 extracts the block in the compressed file F2 from the top and encrypts the extracted block. For example, when the encryption unit 106 has extracted the top block, the encryption unit 106 performs the EOR operation between the initial value IV and the data in the top block that has been subjected to the compression encoding and then stores the result of the EON operation in the storage area A6. When the encryption unit 106 has extracted the blocks subsequent to the top block, the encryption unit 106 performs the EOR operation between the data in the block subjected to the compressed code and the data in the immediately previous encrypted block and then stores the result of the EON operation in the storage area A6. The encryption unit 106 performs an operation of the result of the EOR operation, by using the affine encryption function (Ek) and stores the obtained block in the storage area A7 as the compression encryption block. The encryption unit 106 outputs the data in the compression encryption block stored in the storage area A7 to the file yam write unit 107. Furthermore, the encryption unit 106 encrypts the compressed data and the trailer unit in the compressed file F2.

The file write unit 107 is a processing unit that acquires the compression encryption block from the encryption unit 106 and writes the acquired compression encryption block in the compression encryption file F3.

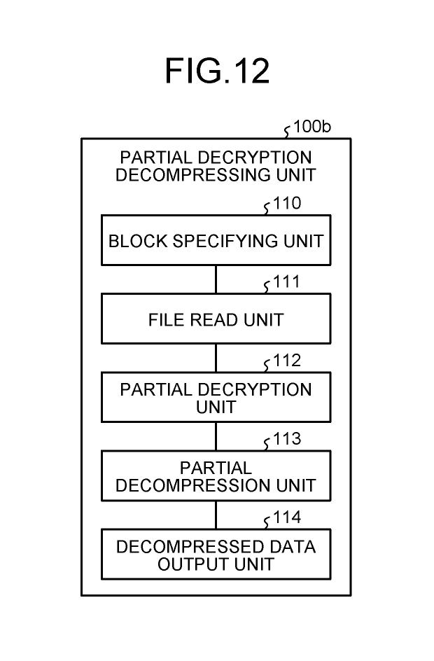

FIG. 12 is a functional block diagram illustrating the configuration of a partial decryption decompressing unit according to the embodiment. As illustrated in FIG. 12, the partial decryption decompressing unit 100b includes a block, specifying unit 110, a file read unit 111, a partial decryption unit 112, a partial decompression unit 113, and a decompressed data output unit 114.

The block specifying unit 110 is a processing unit that specifies a compression encryption block that is to be subjected to the partial decryption decompression and that is stored in the compression encryption file F3. When the block specifying unit 110 acquires a read command that indicates the start and the end positions of the source file F1, the block specifying unit. 110 decrypts the logical address table L1. For example, the block specifying unit 110 decrypts the block located at the position indicated by the pointer, which is stored in the header unit in the compressed file F2, to the logical address table L1. Consequently, the block specifying unit 110 can decrypt the logical address table L1. The block specifying unit 110 refers to the logical address table, L1 and specifies the block (compression encryption block) that includes therein the start and the end positions as the decompression target. The block specifying unit 110 outputs the compression encryption block specified as the decompression target to the file read unit 111.

The file read unit 111 is a processing unit that reads the compression encryption block specified as the decompression target and the compression encryption block needed for the decryption that are stored in the compression encryption file F3. The file read unit 111 reads the compression encryption block specified as the decompression target from the compression encryption file F3 and outputs the read block to the partial decryption unit 112. The file read unit 111 reads, as the compression encryption block needed for the decryption from the compression encryption file F3, the compression encryption block that is immediately previous to the compression encryption block specified as the decompression target and then outputs the read block to the partial decryption unit 112.

The partial decryption unit 112 is a processing unit that decrypts the block (compression encryption block) specified as the decompression target. The partial decryption unit 112 performs an operation of the data in the compression encryption block specified as the decompression target by using the decryption function (Dk). The partial decryption unit 112 stores the result: of the operation in the storage area B1. The partial decryption unit 112 stores, in the storage area B2, the data in the compression encryption block that is one block previous to the compression encryption block specified as the decompression target. The partial decryption unit 112 performs the EOR operation between the data stored in the storage area B1 and the data stored in the storage area B2 and stores the result of the SCE operation in the storage area B3. Consequently, for the compression encryption block specified as the decompression target, the partial decryption unit 112 generates a compression block including the number of compressed codes, the compressed data, and the padding. The partial decryption unit 112 outputs the compression block to the partial decompression unit 113.

The partial decompression unit 113 is a processing unit that decompresses a decrypted compression block. The partial decompression unit 113 reads the compressed data in the compression block and decompresses the compressed data on the basis of the identifier of the read compressed data. The identifier is associated with the first bit in the compressed data. The partial decompression unit 113 determines the identifier of the compressed data. If the identifier of the compressed data is “0”, the partial decompression unit 113 decompresses the compressed data by using the Nodeless tree 60 that is used for the decompression. For example, the data structure of the Node less tree 60 that is used for the decompression corresponds to the data structure illustrated in FIG. 10. The partial decompression unit 113 compares the bit string allocated to each of the branches of the Nodeless tree 60 with the compressed data excluding the identifier and specifies a leaf associated with a branch that has the same bit string as the compressed data. The partial decompression unit 113 refers the specified leaf, generates a character string indicated by the pointer for the word as the decompressed data of the compressed data, and stores the generated decompressed data in the storage area B6.

If the identifier of the compressed data is “1”, the partial decompression unit 113 decompresses the compressed data by using the information in the dynamic dictionary unit stored in the storage area 82. For example, by removing the identifier from the compressed data, the partial decompression unit 113 acquires the registration number of the dynamic dictionary unit. The partial decompression unit 113 compares the acquired registration number with the reference table T1 and specifies the storage position and the data length of the decompressed data stored in the storage area B2. The partial decompression unit 113 acquires, from the storage area B2, the character string associated with the storage position and the data length and generates the acquired character string as the decompressed data. The partial decompression unit 113 stores the generated decompressed data in the storage area B6,

The decompressed data output unit 114 is a processing unit that outputs the decompressed data that has been subjected to the partial decryption and decompression. The decompressed data output unit 114 extracts, from the decompressed data written in the storage area B6, the decompressed data located at the start and the end positions specified by the read instruction. The decompressed data output unit 114 outputs the extracted decompressed data to the application indicated by the read command.

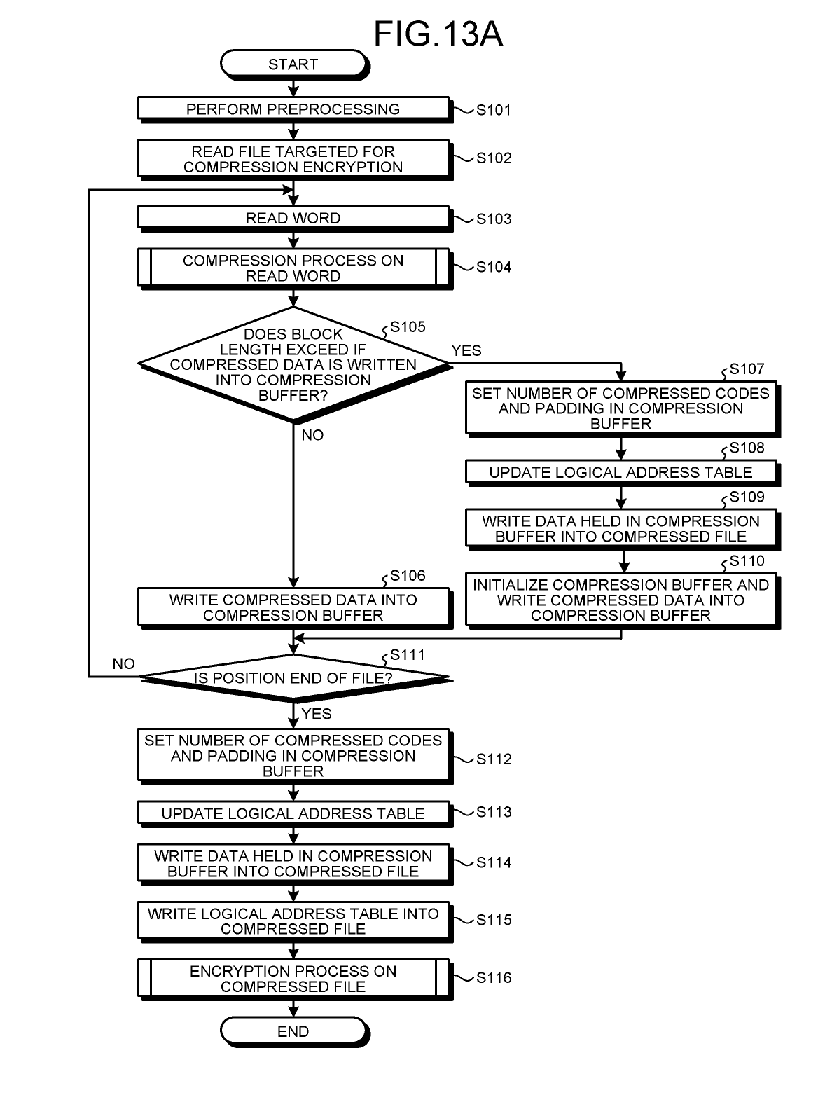

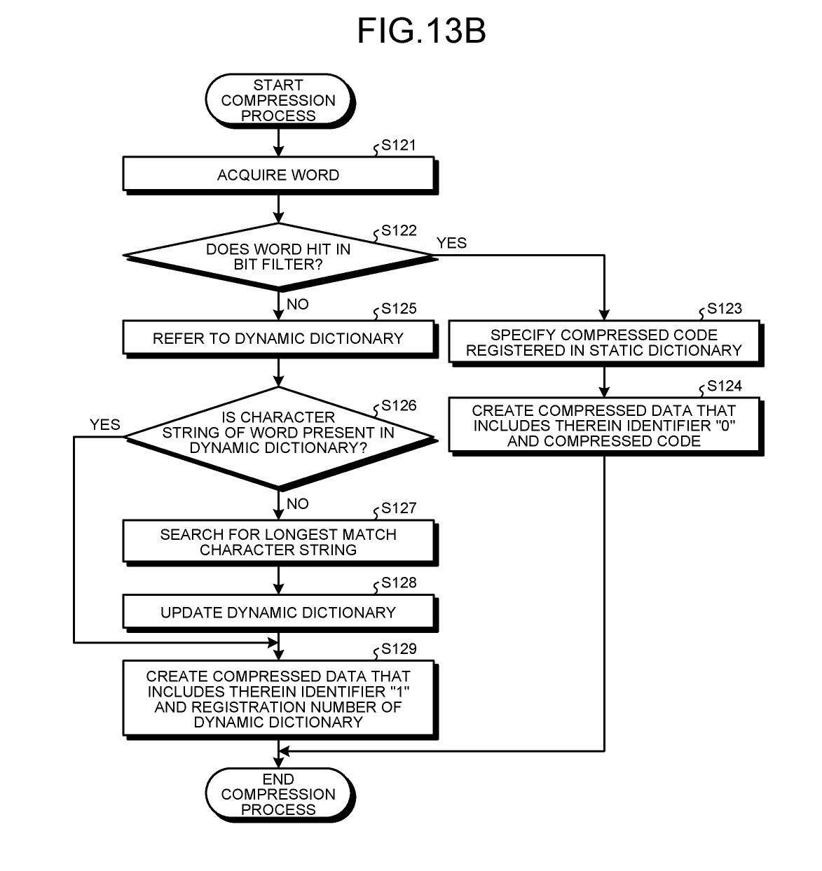

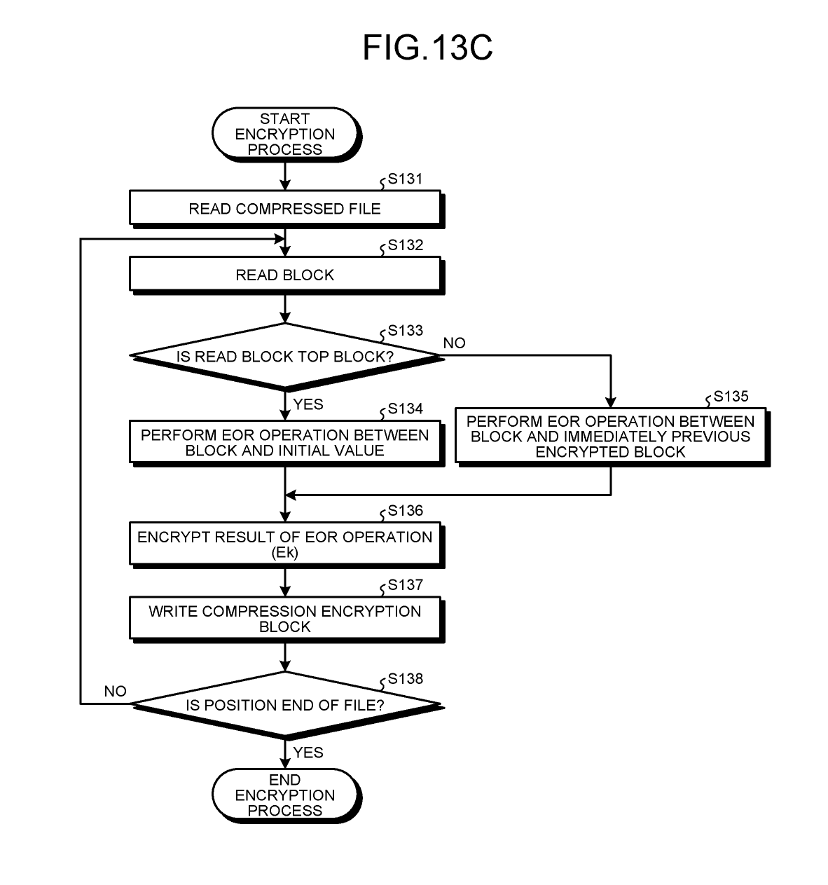

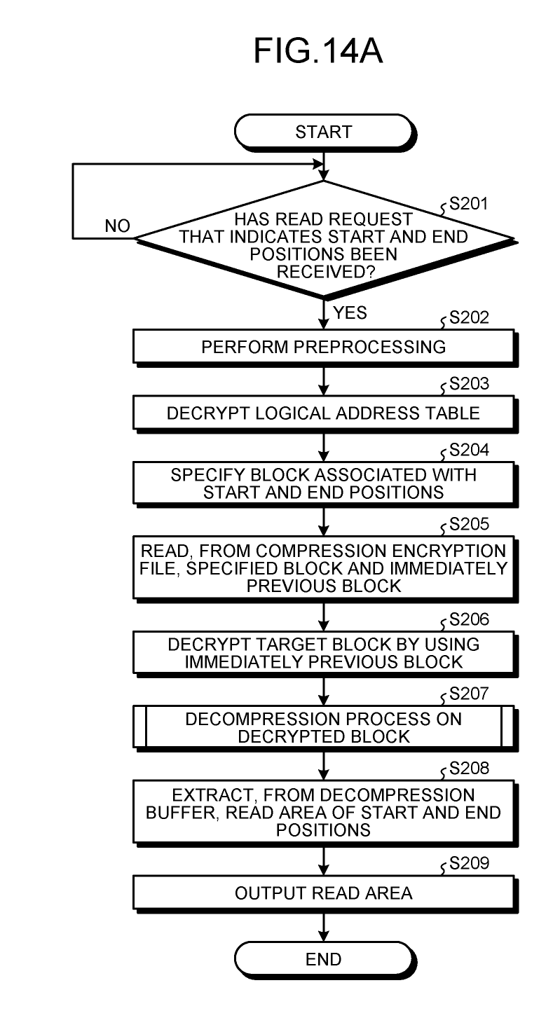

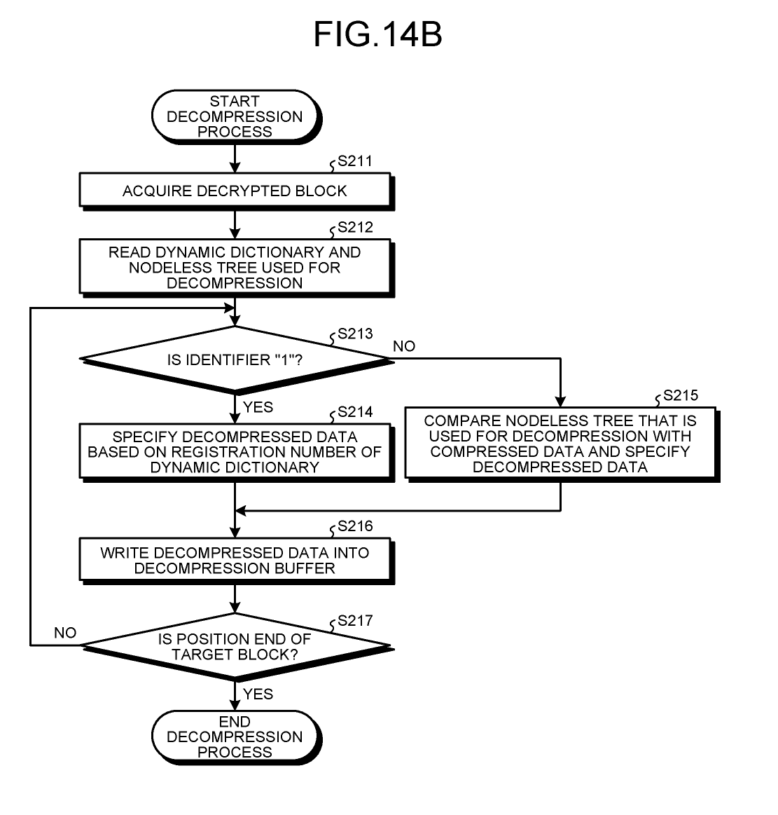

In the following, the flow of the processes performed by the compression encrypting unit 100a and the partial decryption decompressing unit 100b illustrated in FIGS. 13A to 13C and FIGS. 14A and 14B will be described.

FIGS. 13A to 13C are flowcharts each illustrating the flow of a process performed by the compression encrypting unit according to the embodiment. As illustrated in FIG. 13A, the compression encrypting unit 100a performs preprocessing (Step S101). In the preprocessing at Step S101, the compression encrypting unit 100a reserves, for example, the storage areas A1 to A7 in the storing unit 100c.

The compression encrypting unit 100a reads the source file F1 targeted for the compression encryption (Step S102) and reads a word (Step S103). The compression encrypting unit 100a performs the compression process on the read word (Step S104). The flow of the compression process will be described later.

The compression encrypting unit 100a determines whether the block length exceeds if the compression encrypting unit 100a writes the compressed data into the storage area A4 (compression buffer) (Step S105).

If the block length does not exceed if the compression encrypting unit 100a writes the compressed data into the storage area A4 (compression buffer) (No at Step S105), the compression encrypting unit 100a writes the compressed data into the storage area A4 (compression buffer) (Step S106). Then, the compression encrypting unit 100a proceeds to Step S111.

In contrast, if the block length exceeds if the compression encrypting unit 100a writes the compressed data into the storage area A4 (compression buffer) (Yes at Step S105), the compression encrypting unit 100a does not perform the process of writing the compressed data into the compression buffer. Then, the compression encrypting unit 100a sets the number of compressed codes and the padding in the compression buffer (Step S107). For example, the compression encrypting unit 100a writes, into the top in the compression buffer, the number of compressed codes that indicates the number of pieces of compressed data that have already been written in the compression buffer. The compression encrypting unit 100a complements the remaining area in the compression buffer by using the padding. Consequently, the data in the block is generated in the compression buffer.

Subsequently, the compression encrypting unit 100a updates the logical address table L1 (Step S108). For example., the compression encrypting unit 100a adds, to the logical address table L1, the record that includes therein the target word, the source address, and the compression destination address associated with the subject block. In the target word, the top word in the source file F1 associated with the subject block is set. In the source address, the address (address number) of the top word in the source file F1 is set. In the compression destination address, the address (the address number and the bit offset) of the subject block in the compressed file F2.

The compression encrypting unit 100a writes the data held in the storage area A4 (a compression buffer) into the compressed file F2 (Step S109). Then, the compression encrypting unit 100a initializes the compression buffer and writes the compressed data into the compression buffer (Step S110). Then, the compression encrypting unit 100a proceeds to Step S111.

At Step S111, the compression encrypting unit 100a determines whether the position is the end of the source file F1 (Step S111). If the position is not the end of the source file F1 (No at Step S111), the compression encrypting unit 100a proceeds to Step S103.

In contrast, if the position is the end of the source file F1 (Yes at Step S111), the compression encrypting unit 100a performs the following process in order for the compressed data in the storage area AA (compression buffer) to generate data in the block. Namely, the compression encrypting unit 100a sets the number of compressed codes and the padding in the compression buffer (Step S112). The compression encrypting unit 100a updates the logical address table L1 (Step S113). The compression encrypting unit 100a writes the data held in the compression buffer into the compressed file F2 (Step S114).

The compression encrypting unit 100a writes the logical address table L1 into the trailer unit in the compressed file F2 (Step S115). In addition, the compression encrypting unit 100a writes, into the header unit in the compressed file F2, the pointer to the logical address table L1 stored in the trailer unit.

Then, the compression encrypting unit 100a performs the encryption process on the compressed file F2 (Step S116) and ends the compression encryption process. Furthermore, the flow of the encryption process will be described later.

FIG. 135 is a flowchart illustrating the flow of a compression process from among the processes performed by the compression encrypting unit 100a. As illustrated in FIG. 13B, when the compression encrypting unit 100a acquires a word (Step S121), the compression encrypting unit 100a compares the character string of the word with the bit filter C1 and determines whether the character string of the word hits in the bit filter C1 (Step S122).

If the character string of the word hits in the bit filter C1 (Yes at Step S122), the compression encrypting unit 100a specifies the compressed code registered in the static dictionary C1 (Step S123). The compression encrypting unit 100a generates compressed data that includes therein the identifier “0” and a compressed code (Step S124) and ends the compression process.

In contrast, if the character string of the word does not hit in the bit filter C1 (No at Step S122), the compression encrypting unit 100a refers to the dynamic dictionary (Step S125). Then, the compression encrypting unit 100a determines whether the character string of the word has already been present in the dynamic dictionary (Step S126). If the character string of the word has already been present in the dynamic dictionary (Yes at Step S126), the compression encrypting unit 100a proceeds to Step S129.

In contrast, if the character string of the word is not present in the dynamic dictionary (No at Step S126), the compression encrypting unit 100a searches for the longest match character string (Step S127). The compression encrypting unit 100a updates the dynamic dictionary (Step S128) and proceeds to Step S129.

At Step S129, the compression encrypting unit 100a generates compressed data that includes therein the identifier “0” and the registration number of the dynamic dictionary (Step S129) and ends the compression process.

FIG. 13C is a flowchart illustrating the flow of an encryption process from among the processes performed by the compression encrypting unit 100a. As illustrated in FIG. 13B, the compression encrypting unit 100a reads the compressed file F2 (Step S131) and reads a block (compression block) (Step S132).

The compression encrypting unit 100a determines whether the read block is the top block (Step S133). If the read block is the top block (Yes at Step S133), the compression encrypting unit 100a performs the EOR operation between the data in the subject block and the initial value IV (Step S134). In contrast, if the read block is not the top block (No at Step S133), the compression encrypting unit 100a performs the EOR operation between the data in the subject block and the data in an immediately previous encrypted block (Step S135).

Subsequently, the compression encrypting unit 100a performs an operation of the result of the EOR operation by using the affine encryption function (Ek) and encrypts the obtained result (Step S136). Consequently, the compression encrypting unit 100a generates the block (compression encryption block) that is obtained by encrypting the read block. Then, the compression encrypting unit 100a writes the data of the compression encryption block into the compression encryption file F3 (Step S137).

The compression encrypting unit 100a determines whether the position is the end of the compressed file F2 (Step S138). If the position is not the end of the compressed file F2 (No at Step S138), the compression encrypting unit 100a proceeds to Step S132 in order to read the subsequent block. If the position is the end of the compressed file F2 (Yes at Step S138), the compression encrypting unit 100a ends the encryption process.

FIGS. 14A and 14B are flowcharts each illustrating the flow of a process performed by the partial decryption decompressing unit according to the embodiment. As illustrated in FIG. 14A, the partial decryption decompressing unit 100b determines whether a read request that indicates the start and the end positions has been received (Step S201) if a read request that specifies the start and the end positions has not been received (No at Step S201), the partial decryption decompressing unit 100b repeats the determination process until a read request is received.

In contrast, if a read request that specifies the start and the end positions has been received (Yes at Step S201), the partial decryption decompressing unit 100b performs preprocessing (Step S202). In the preprocessing performed at Step 3202, the partial decryption decompressing unit 100b reserves, for example, the storage areas B1 to B6 in the storing unit 100c.

The partial decryption decompressing unit 100b decrypts the logical address table L1 (Step S203). For example, the partial decryption decompressing unit 100b decrypts the block located at the position indicated by the pointer to the logical address table L1 stored in the header unit.

Then, the partial decryption decompressing unit 10b specifies the block associated with the start and the end positions (Step S204). For example, the partial decryption decompressing unit 100b refers to the logical address table L1 and specifies, as the decompression target, the block (compression encryption block) that includes therein the start and the end positions.

The partial decryption decompressing unit 100b reads, from the compression encryption file 53, the block specified as the decompression target and the immediately previous block (Step S205). Then, the partial decryption decompressing unit 100b decrypts, by using the immediately previous block, the block specified as the decompression target (Step S206).

The partial decryption decompressing unit 100b performs the decompression process on the decrypted block and writes the result of the decompression process into the storage area 86 (decompression buffer) (Step S207). The flow of the decompression process performed on the decrypted block will be described later.

The partial decryption decompressing unit 100b extracts, from the decompression buffer, a read area of the start and the end positions (Step S208). Then, the partial decryption decompressing unit 100b outputs the decompressed data in the extracted read area on the basis of the request (Step S209) and ends the partial, decryption/decompression process.

FIG. 148 is a flowchart illustrating the flow of a decompression process from among the processes performed by the partial decryption decompressing unit 100b. As illustrated in FIG. 148, when the partial decryption decompressing unit 100b acquires the decrypted block as the decompression target (Step S211), the partial decryption decompressing unit 100b reads the Nodeless tree 60 that is used for decompression and the dynamic dictionary (Step S212). For example, the partial decryption decompressing unit 100b decrypts the information about the dynamic dictionary unit stored in the encrypted trailer unit in the compression encryption file F3. Then, the partial decryption decompressing unit 100b stores, in the storage area B5, the information about the decrypted dynamic dictionary unit.

The partial decryption decompressing unit 100b determines whether the identifier of the compressed data is “1” (Step S213). If the identifier of the compressed data is “1” (Yes at Step S213), the partial decryption decompressing unit 100b specifies the decompressed data on the basis of the registration number of the dynamic dictionary (Step S214) and proceeds to Step S216.

In contrast, if the identifier is “0” (No at Step S213), the partial decryption decompressing unit 100h compares the Nodeless tree 60 that is used for the decompression with the compressed data, specifies the decompressed data (Step S215), and proceeds to Step S216.

At Step S216, the partial decryption decompressing unit 100b writes the decompressed data into the storage area B6 (decompression buffer) (Step S216).

The partial decryption decompressing unit 100b determines whether the position is the end of the block that is the decompression target (Step S217). If the position is not the end of the block that is the decompression target (No at Step S217), the partial decryption decompressing unit 100b proceeds to Step S213. In contrast, if the position is the end of the block that is the decompression target (Yes at Step S217), the partial decryption decompressing unit 100b ends the decompression process.

In the embodiment, a description has been given in which the storage location of the logical address table L1 stored in the trailer unit is stored in the pointer of the header unit in the compressed file F2. However, the storage, location of the logical address table L1 stored in the trailer unit is not limited thereto and may also be stored in an independent trailer unit. In such a case, the independent trailer unit is present at the top in the independent block. Consequently, the information processing apparatus can refer to the logical address table L1 that is in a predetermined trailer unit when the partial decryption and decompression is performed.

Furthermore, if the partial decryption and decompression, i.e., partial decryption and partial decompression, are not performed, the logical address table L1 (association information) does not need to be included in the compressed file F2. Even if the logical address table L1 is not included in the compressed file F2, if the logical address table L1 can be shared (obtained) in another way, partial decryption and partial decompression are possible.

In the following, an advantage of the information processing apparatus 100 according to the embodiment will be described. When the information processing apparatus. 100 compresses a file performed by using a compressed code, the information processing apparatus 100 sequentially generates, from the source file F1 in units of blocks with a fixed length, the compressed data that includes therein a compressed code. The information processing apparatus 100 creates the logical address table L1 in which the top compressed code. In the generated compressed data in each block is associated with the position of the data associated with the compressed code in the source file F1. The information processing apparatus 100 encrypts the compressed data in units of blocks. Consequently, with the information processing apparatus 100, by using the logical address table L1, an encrypted block can be associated with the position in the source file F1 and thus partial decryption and decompression can be performed. Furthermore, a compressed code can be prevented from being decoupled between blocks that have the fixed length.

Furthermore, the information processing apparatus 100 according to the embodiment registers the logical address table L1 in the trailer unit in the compressed file F2 in which the compressed data generated in units of blocks is generated and registers the top position of the trailer unit in the header unit in the compressed file F2. Consequently, with the information processing apparatus 100, the registration position in the logical address table L1 can be easily specified and thus partial decryption and decompression can he performed at a high speed.

Furthermore, the information processing apparatus 100 according to the embodiment encrypts the logical address table L1 registered in the trailer unit in units of blocks and registers the encrypted logical address table L1 in the area that is associated with the trailer unit in the compression encryption file F3. Consequently, with the information processing apparatus 100, the registration position of the encrypted logical address table L1 can be easily specified and the encrypted logical address table L1 can be decrypted first. Furthermore, by using the decrypted logical address table L1, partial decryption and decompression can be performed at a high speed.

Furthermore, the information processing apparatus 100 according to the embodiment sets the number of compressed codes in the top of the block. Consequently, with the information processing apparatus 100, the number of compressed codes included in a block can be detected and thus the number of compressed codes to be decompressed can be specified.

Furthermore, when the information processing apparatus 100 according to the embodiment acquires a read request that specifies the start and the end positions at the time of decompression, the information processing apparatus 100 specifies, on the basis of the logical address table L1, a block associated with the start and the end positions. The information processing apparatus 100 decrypts the specified block. The information processing apparatus 100 decompresses the compressed code that is included in the decrypted block. The information processing apparatus 100 extracts, from the decompressed data, the data associated with the start and the end positions. Consequently, with the information processing apparatus 100, it is possible to perform partial decryption and decompression in accordance with the start and the end positions of the read request.

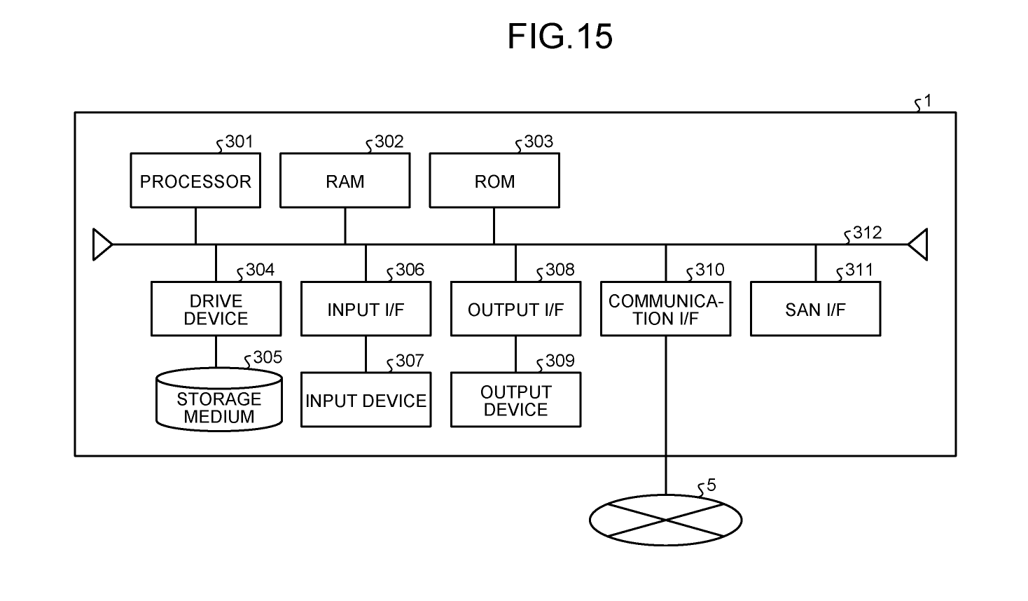

In the following, hardware and software that are used in the embodiment will be described. FIG. 15 is a block diagram illustrating an example of hardware configuration of a computer 1. The computer 1 includes, for example, a processor 301, a random access memory (RAM) 302, a read only memory (ROM) 303, a drive device 304, a storage medium 305, an input interface (I/F) 306, an input device 307, an output interface (I/F) 308, an output device 309, a communication interface (I/F) 310, a storage area network (SAN) interface (I/F) 311, a bus 312, and the like. Each of the pieces of the hardware is connected via the bus 312.

The RAM 302 is a memory device that allows data items to be read and written. For example, a semiconductor memory, such as a static RAN (SRAM), a dynamic RAM (DRAM), or the like, is used or, instead of a RAM, a flash memory or the like is used. The ROM 303 also includes a programmable ROM (PROM) or the like. The drive device 304 is a device that performs at least one of the reading and writing of information recorded in the storage medium 305. The storage medium 305 stores therein information that is written by the drive device 304. The storage medium 305 is for example, a flash memory, such as a hard disk, a solid state drive (SSD), or the like, or a storage medium, such as a compact disc (CD), a digital versatile disc (DVD), a blue-ray disk, or the like. Furthermore, for example, regarding the plurality types of storage media, a computer 300 provides the drive device 304 and the storage medium 305.

The input interface 306 is a circuit, that is connected to the input device 307 and that transmits the input signal received from the input device 307 to the processor 301. The output interface 308 is a circuit that is connected to the output device 309 and that allows the output device 309 to perform an output in accordance with an instruction from the processor 301. The communication interface 310 is a circuit that controls communication via a network 5. The communication interface 310 is, for example, a network interface card (NIC) or the like. The SAN interface 311 of a circuit that controls communication with a storage device connected to the computer 1 via the storage area network The SAN interface 311 is, for example, a host bus adapter (NBA) or the like.

The input device 307 is a device that sends an input signal in accordance with an operation. The input device 307 is, for example, a keyboard; a key device, such as buttons attached to the main body of the computer 1; or a pointing device, such as a mouse, a touch panel, or the like. The output device 309 is a device that outputs information in accordance with control performed by the computer 1. The output device 309 is, for example, an image output device (display device), such as a display or the like, or an audio output device, such as a speaker or the like. Furthermore, for example, an input-output device, such as a touch screen or the like, is used as the input device 307 and the output device 309. Furthermore, the input device 307 and the output device 309 may also be integrated with the computer 1 or may also be devices that are not included in the computer 1 and that are, for example, connected to the computer 1 from outside.

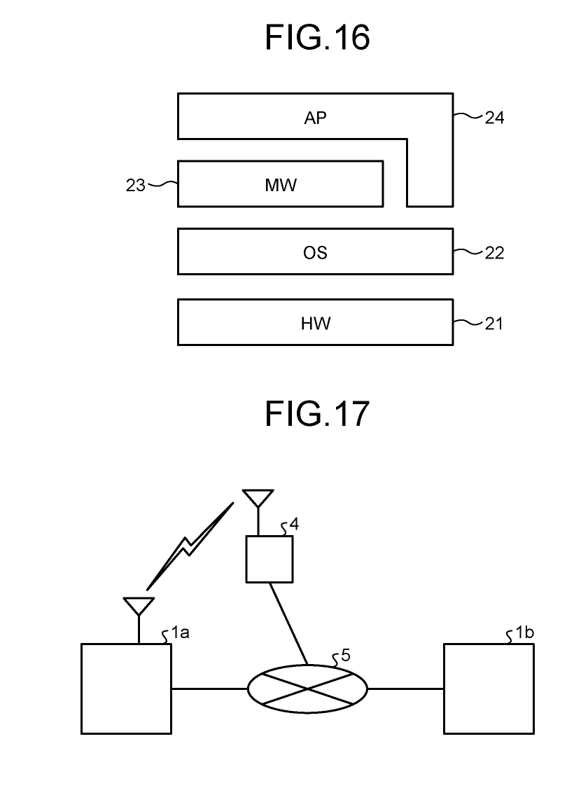

For example, the processor 301 reads a program stored in the ROM 303 or the storage medium 305 to the RAM 302 and performs, in accordance with the procedure, of the read program, the process of the compression encrypting unit 100a or the process of the partial decryption decompressing unit 100b. At that time, the RAM 302 is used as a work area of the processor 301. The function of the storing unit 100c is implemented by the ROM 303 and the storage medium 305 storing program files an application program (AP) 24, middleware (MW) 23, an OS 22, or the like, which will be described later) or data file, (the source file F1, the compressed file F2, the compression encryption file F3, or the like targeted for compression) and by using the RAM 302 as the work area of the processor 301. The program read by the processor 301 will be described with reference to FIG. 16.

FIG. 16 is a schematic diagram illustrating a configuration example of a program operated by the computer 1. In the computer 1, the operating system (OS) 22 that controls a hardware group (HW) 21 (301 to 312) illustrated in FIG. 16 operates. The processor 301 operates in accordance with the procedure of the OS 22 and then the control and management of the hardware group 21 is performed, whereby the processes according to the application program 24 or the middleware 23 are performed in the hardware group 21. Furthermore, in the computer 1, the middleware: 23 or the application program 24 is read into the RAM 302 and is executed by the processor 301.

If a compression encryption function is called, the processor 301 performs processes based on at least a part of the middleware 23 or the application program 24, whereby the function of the compression encrypting unit 100a is implemented. (by the processor 301 performing the processes by controlling the hardware group 21 on the basis of the OS 22). Furthermore, if the partial decryption/decompression function is called, the processor 301 performs processes based on at least a part of the middleware 23 or the application program 24, whereby the function of the partial decryption decompressing unit 100b is implemented by the processor 301 performing the processes by controlling the hardware group 21 on the basis of the OS 22). The compression encryption function and the partial decryption/decompression function may also be included in the application program. 24 itself or may be a part of the middleware 23 that is executed by being called in accordance with the application program 24.

FIG. 17 is a schematic diagram illustrating a configuration example of a device in a system of an embodiment. The system illustrated in FIG. 17 includes a computer 1a, a computer 1b, a base station 4, and the network 5. The computer 1a is connected to the network 5 that is connected to the computer 1b by using wireless or wired connection.

The compression encrypting unit 100a and the partial decryption decompressing unit 100b illustrated. in FIG. 8 may also be included in either the computer 1a or the computer 1b illustrated in FIG. 17. The computer 1b may also include the compression encrypting unit 100a, whereas the computer 1a may also include the partial decryption decompressing unit 100b. Alternatively, the computer 1b may also in the compression encrypting unit 100a, whereas the computer la may also include the partial decryption decompressing unit 100b. Furthermore, both the computer 1a and the computer 1b may also include the compression encrypting unit 100a and the partial decryption decompressing unit 100b.

in the following, a part of a modification of the above described embodiment will be described. In addition to the modification described below, design changes can be appropriately made without departing from the scope of the present invention. The target for the compression encryption process may also be, in addition to data in a file, monitoring messages that are output from a system. For example, a process that compresses and encrypts the monitoring messages that are sequentially stored in a buffer by using the compression encryption process described above and that stores the compressed messages as log files is performed. Furthermore, for example, the compression and encryption may also be performed for each page in a database or may also be performed in units of multiple pages.

In the following, the data targeted for the compression encryption process described above is not limited to, as described above, character information. Information about only numeric values may also be used or, alternatively, the compression encryption process described above may also be used for data on image, voice, or the like. For example, in a file that contains a large amount of data obtained from speech synthesis or the like, because many repetitions are included in data, a compression ratio is expected to be improved from the dynamic dictionary. Of course, if a part of it is used, an excessive decompression process is suppressed due to partial decryption and decompression. Furthermore, for moving images captured by a fixed camera, because images of frames are similar, many repetitions are included. Consequently, by using the compression encryption process described above, the same advantage as that of the document data or the voice data can be obtained.

According to an aspect of an embodiment, an advantage is provided in that, for parts divided in units of encryptions in a file, partial decryption and decompression can be performed. Furthermore, it is possible to prevent a compressed code from being decoupled between blocks with a fixed length.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate, to a showing of the superiority and inferiority of the invention. Although the embodiments of the present invention have been described in detail, it should be understood that the various changes, substitutions, and alterations could be made hereto without departing from the spirit and scope, of the invention.

What is claimed is:

1. A non-transitory computer readable recording medium having stored therein an encrypting program that causes a computer to execute a process comprising:
generating an encoded data from a target file, in units of blocks with a fixed length;
creating association information for a plurality of blocks in the encoded data, the association information associating each of a plurality of top encoded codes and each of a plurality of in file positions of the plurality of blocks, the plurality of top encoded codes being positioned at a beginning of the each of the plurality of blocks in the encoded data, the plurality of in-file positions being positions of the plurality of blocks in the target file; and
encrypting the encoded data in units of the blocks.

2. The non-transitory computer-readable recording medium according to claim 1, wherein the process further comprising:
registering, in a first area of data in which the encoded data is stored, the association information created by the creating, and
registering a top position in the first area in a second area of the data.

3. The non-transitory computer-readable recording medium according to claim 2, wherein the encrypting includes encrypting, in units of the blocks, the association information registered in the first area.

4. The non-transitory computer-readable recording medium according to claim 1, wherein the process further comprising setting the number of compressed codes at the top of the encoded data generated by the generating.

5. The non-transitory computer-readable recording medium according to claim 1, wherein the process further comprising:
specifying, when a decoding request that indicates a start and an end positions at the time of decoding is acquired, a block associated with the start and the end positions on the basis of the association information;
decrypting the block specified by the specifying;
decoding an encoded code included in the block decrypted by the decrypting; and
extracting, from the data decoded by the decoding, data that is associated with the start and the end positions.

6. An encrypting apparatus comprising:
a generating unit that generates an encoded data from a target file, in units of blocks with a fixed length;
a creating unit that creates association information for a plurality of blocks in the encoded data, the association information associating each of a plurality of top encoded codes and each of a plurality of in-file positions of the plurality of blocks, the plurality of top encoded codes being positioned at a beginning of the each of the plurality of blocks in the encoded data, the plurality of in-file positions being positions of the plurality of blocks in the target file; and
an encryption unit that encrypts the encoded data in units of the blocks.

7. An encrypting method comprising:
generating, performed by a computer, an encoded data from a target file, in units of blocks with a fixed length;
creating, performed by the computer, association information for a plurality of blocks in the encoded data, the association information associating each of a plurality of top encoded codes and each of a plurality of in-file positions of the plurality of blocks, the plurality of top encoded codes being positioned at a beginning of the each of the plurality of blocks in the encoded data, the plurality of in-file positions being positions of the plurality of blocks in the target file; and
encrypting, performed by the computer, the encoded data in units of the blocks.
